(19) United States
(12) Patent Application Publication
(10) Pub. No.: US 2013/0092088 A1
(43) Pub. Date: Apr. 18, 2013

(54) Portable Pet Restraint Device

(71) Applicants: Tim Sharp, Beaverton, OR (US); Laurel Sharp, Beaverton, OR (US)

(72) Inventors: Tim Sharp, Beaverton, OR (US); Laurel Sharp, Beaverton, OR (US)

(21) Appl. No.: 13/552,793

(22) Filed: Jul. 19, 2012

Related U.S. Application Data
(60) Provisional application No. 61/546,691, filed on Oct. 13, 2011.

(51) Int. Cl. A01K 1/04; A01K 5/01

(52) U.S. Cl. 119/61.5; 119/786

(57) ABSTRACT

A restraining device for temporarily coupling a domestic animal to a floor includes a post having a retaining lip and tether-resting channel. A locking plate positions on the post below resting channel. A first and second locking wing hingeably mount to the post and are operable from a closed position to an open position, and each locking wing includes a top-mounted locking feature retainer to selectively engage the locking plate. And, the first and second locking wing each respectively further comprising a plurality of carpet-engaging spikes. A smooth floor attachment device selectively couples to the first and second locking wings. The smooth floor attachment device includes a base having oppositely disposed pair of retainers on a top portion and an adhesive strip or other mechanism for selectively attaching the base to the floor on a bottom portion.

### PRIORITY CLAIM

The present application claims benefit under 35 USC Section 119(e) of U.S. Provisional Patent Application Ser. No. 61/546,691 filed on Oct. 13, 2011: The present application is based on and claims priority from this application, the disclosure of which is hereby expressly incorporated herein by reference.

### FIELD OF THE INVENTION

This invention relates generally to restraining and confining device and, more particularly, to portable physical restraint devices adapted for domestic pet use, particularly for indoor use.

### BACKGROUND

Domestic animals, particularly pets that reside inside the home of an owner, need to be restrained at times for various reasons including safety of the pet and convenience of the owner.

Various attempts to confine pets to a specific physical area inside or outside a home include the use of an animal run, a crate, a chain coupled to a post or other immovable object, fencing a portion of the yard, using “baby gates” to restrict access from or to an area inside the home, closing the pet into one room of the house, and fastening a leash to a piece of furniture. Each of these methods and devices for restraining a pet has advantages and disadvantages.

One common problem to these known methods and devices is a lack of portability. For example, a fence becomes a fixed improvement to the land and cannot be readily and practically moved when traveling with the pet. A crate or cage is often bulky and cumbersome to move, and when in-place offers a very restricted area for the pet that is overly confining for long periods of time. Fastening a leash to a heavy piece of furniture is portable, compact, easy to travel with, but leaves the owner at the mercy of the type of furniture found in the hotel room or other venue: Further, many dogs, for example, can overpower the weight of the piece of furniture, thus dragging the furniture around, damaging the property or injuring itself in the process. So, there remains a need for a portable restraint that secures the pet in a desired physical area, but still provides ample space for the pet to walk, stretch, lie down, reach food and water, and perhaps reach a bladder and waste relief area. Such a device should also work indoors.

Several known devices are designed to work outdoors by either staking or screwing a post or tether into the ground. Examples of this include a tether restraint apparatus and method described by Moran in U.S. Pat. No. 7,921,815 issued on 12 Apr. 2011. Moran teaches a device having two folding members, pivotally connected, a tether attachment, and two stakes. Simson et al. in U.S. Pat. No. 7,866,282 issued on 11 Jan. 2011, teaches yet another animal restraint apparatus and related method consisting of a spool containing a flexible tension link attached to a vertical member having a screw or screw-like helical anchor portion. Kramer describes a staked device in U.S. Pat. No. 7,730,852 issued on 8 Jun. 2010. And, Willinger in U.S. Pat. No. 6,374,777 issued on 23 Apr. 2002 teaches a tangle free pet restraint consisting of an elongated stake having a ground-inserable section at the lower end. Also, U.S. Published Application No. 2002/0066417 on 6 Jun. 2002 teaches a tethering system including a ground station for inserting into the ground.

Each of the above devices require a stake or similar appendage to pierce the ground, and accordingly, is ill-suited for indoor use because there is no teaching in these references of how the ground-inserting member can penetrate the floor without permanent damage to the floor, or to the insertion member, or both. Further, these devices are inoperable for insertion into a floor because it would destroy the floor, and even if that were not objectionable, they would further be inoperable as there would be insufficient friction between the relatively thin floor (as compared to the surface area offered by inserting the same in the earth) and the insertion member. Therefore, there remains a need for a pet restraining device that is better suited for indoor use, outdoor use, or both.

One attempt to provide an improved indoor tether for small dogs is described by Etken in U.S. Pat. No. 5,085,174 issued on Feb. 4, 1992. Etkin teaches a pet trainer consisting of a wide flat panel and continuous peripheral lip. A vertical post screws into the center of the flat panel and a swivel mounts on top of the post. The pet leash or lead attaches to the swivel. Although Etkin's device works well as an indoor restraint, it requires the weight of the panel in combination with a short length of lead to restrict the dog to an area defined by the panel, and such a device is, accordingly, large, bulky, and cumbersome. This is exasperated as the pet size increases and it quickly becomes impractical for larger dogs.

Another portable restraint device also teaches the use of a base panel: Capperrune in U.S. Pat. No. 5,894,748 issued on 20 Apr. 1999 and in U.S. Pat. No. 6,499,436 issued on 31 Dec. 2001 both describe a base panel with an outer perimeter and a securement strap attached at one end to the center of the base panel. The animal is confined to the space defined by the base, and as such, the animal's own weight is used to keep the base panel in place and inhibit the animal from moving. One limitation of this device is that it overly confines the animal to a very small area, and forces the animal to stand in its own excretions, which is at best inhumane and more likely negligent—thus, Capperrune's device must only be used for extremely short period's of time and under constant supervision, thus drastically reducing the usefulness of the device for restraining a pet.

Other known restraint devices consist of a weighted member having a means for temporarily coupling a lead or leash to the weighted member. Such examples of this include Brown's device described in U.S. Pat. No. 6,578,528 issued 17 Jun. 2003 and Hourihan's device described in U.S. Pat. No. 6,435,137 issued on 20 Aug. 2002. These devices rely on the weight of the weighted member and the friction between this member and the surface (ground, deck, patio, indoor flooring, etc.) to restrict the dog to a radius of movement defined by the weighted device at the center and the length of the attached leash. However, such weighted members have inherent limitations and many excited or strong dogs can easily pull or drag the weighted member across the surface. So, there yet remains a need of an indoor restraint device that does not move when a dog pulls hard on it.

Thus, there still remains a need for a portable restraint device that can quickly be used to temporarily physically confine a pet indoors to prevent the pet from running away, damaging property, tangling the leash, keeping the pet safe from other household pets, yet enable the pet to be indoors with the family to avoid feelings of isolation and neglect. Such a device should readily couple and decouple to normal household floor materials including wall-to-wall carpet, area rugs and hard floor materials including cement, linoleum, hard-woods floors, tile, and the like. Such a device should not tangle the leash.

### SUMMARY OF THE INVENTION

The present invention relates generally to animal restraints and the like. and more specifically to securing small pets to a limited indoor area without need for a cage, gate, door, or other overly restrictive device. The present invention in one embodiment consists of a portable pet restraint that is particularly adaptable for use with small dogs, although it may be used as a restraint for other animals as well.

The portable animal restraint device of a preferred embodiment of the present invention affixes to an existing floor carpel via a first stem containing a central pin to be inserted into the carpet backing, with the first stem remaining atop and perpendicular to the carpet and floor. And, the central pin remains under the carpet backing.

A second stem is lowered vertically to encompass the first stem concentrically, and settles to the floor forming a lateral relationship between itself, the existing carpet, and the inserted pin. The second stem also contains a platform at its base to maintain a perpendicular relationship between the combined unit (first and second stems) and the floor. The platform itself has a serrated bottom edge remaining in contact with the existing carpet to minimize lateral movement of the combined unit. The second stem further includes a knob and setscrew to be driven laterally from itself into the first stem to maintain a temporary, fixed bond between itself and the first stem and attached to the carpet. The second stem also facilitates coupling a primary end of an elastic strap looped around itself. One end of the strap affixes to a pet's collar at its subsequent end via a swivel hook, in total securing the pet to a limited area of the floor.

As needed, the restraint may be simply removed from the carpet and easily transported.

A bent metal pin is located at one end of a plastic stem. A second stem is concentrically placed over the plastic stem and fixed to this first stem via a knob and setscrew. A rotor clip, ratchet-ball, plunger, or friction setting may also act as a fixing device.

The second stem has a platform at its base to maintain a perpendicular orientation to the floor. The underside of the platform is comprised of a serrated edge to limit horizontal movement of the assembled or combined unit. Alternatively, a malleable rubber sheet, or a hook and loop fastener device, or a series of pins may substitute for a serrated bottom edge of the platform.

Looped around the outside of the second stem is the primary end of an elastic strap. The opposite end of the strap contains a tri-glide for strap length adjustability and a swivel hook for affixing to an existing pet collar. A buckle may also be used in place of the tri-glide. A non-elastic Strap or rope may also be used in place of an elastic strap.

The strap is able to freely rotate horizontally around the outer stem allowing the pet to move in an area defined the length of the lead or leash centered on the second stem.

As convenience requires, the restraint may be easily removed from the existing textile by unscrewing the knob and setscrew, vertically lifting off the second stem, and gripping the first stem to remove the metal pin from within the textile backing.

The present invention is intended for use on floor carpet comprised of a gauged secondary backing material (aka “construction yarns”) typically made of durable nylon. The carpet will have been installed via “stretch-in” installation, as opposed to “glue down” installation or being unfixed.

To avoid carpet damage or excessive wear, the Animal Restraint Device is intended for small dogs, typically classified as “toy” breeds, for mixed breeds of similar stature or for larger dogs of mild demeanor. To avoid carpet wear, the Animal Restraint Device may be placed in differing locations of carpet to minimize repeat wear within a single location.

The Animal Restraint Device is easily attached and detached from carpet, as well as of a size and weight to be easily portable for use in homes, offices and while visiting or lodging during travel.

The tether can be any known tether, preferable between about 2-feet and 4-feet long and include a selectively coupling mechanism adapted to engage a d-ring of a dog collar, or a similar feature on a dog harness, or any other known and conventional means for selectively coupling a pet to a tether as would be well understood by those of ordinary skill in this art.

One possible embodiment of the present invention includes:

A restraining device for pets, the device comprising: a first stem comprising floor engaging means comprising either a bent, central pin or a suction cup; the first stem further comprising a base member having bottom surface having any combination of the following, a serrated edge, a rubber or other rubber-like high-friction material, a hook and loop fastener material or a plurality of pins; a second stem adapted to selectively slide over the first stem, the second stem including a retaining lip; a means for selectively coupling the second stem to the first stem, the means comprising any combination of a set screw adapted to pass through the second stem and engage a portion of the first stem, a retaining clip arranged around the second stem to pinch the second stem in place over the first stem, a rotor clip, ratchet-ball, plunger, or friction setting; and a strap having a primary end having a loop and the loop arranging around the second stem below the retaining lip, the strap having an opposite secondary end having a means for attaching the strap to the pet, the means comprising any combination of a swivel hook, clasp, buckle, retaining pin, carabiner, or threaded fastener.

This device further wherein the strap comprises an elastomeric member.

Yet another embodiment includes: A restraining device for pets, the device comprising: a main disc body comprising a locking plate carrying a knob, the knob includes a retaining lip 16 whereby the knob performs two primary functions including a retainer and rest for a tether or strap and to twist the locking plate from a closed position to an open position; a hinge with a hinge pin arranges under the locking plate and further supports a left disc portion and right disc portion and each disc portion includes a retainer; and each disc portion further supports a plurality of carpet engaging gripping elements comprising a plurality of spikes.

This device further includes: A smooth floor attachment having either an adhesive or at least one suction cup mounted to a bottom portion of a low profile tray; and the smooth floor attachment further comprises a base having at least one and preferably two oppositely positioned retainers adapted to selectively receive the main disc body.

This device further includes a screw post adapted to slide over the knob; a bowl including an attachment portion adapted to selectively couple to the screwpost.

### DRAWING

FIG. 1 is an offset top view of the present invention

FIG. 2 is an offset top view of a component of the invention of FIG. 1.

FIG. 3 illustrates the embodiment of FIG. 1 in an environment of use.

FIG. 4 is a front view of a second embodiment of the present invention.

FIG. 5 is a top view of the embodiment of FIG. 1.

FIG. 6 is a front view of the embodiment of FIG. 1.

FIG. 7 is a top view of a third preferred embodiment of the present invention.

FIG. 8 is a front view of the embodiment of FIG. 7.

FIG. 9 shows a release feature of a suction device used in the embodiment illustrated in FIG. 8.

FIG. 10 is a top view of a smooth floor attachment device of a fourth preferred embodiment of the present invention.

FIG. 11 is a front view of the device of FIG. 10.

FIG. 12 is an offset front view of the device of FIG. 10.

FIG. 13 shows the device of FIG. 10 in one environment of use.

FIG. 14 is an offset frontal view of an accessory adapted for use with various versions of the preferred embodiments of the present invention.

FIG. 15 is a front view of the fourth preferred embodiment of the present invention in a closed position.

FIG. 16 is a front view of the embodiment of FIG. 15 in a partially open position.

FIG. 17 is a front view of the embodiment of FIG. 15 in the fully open position.

FIG. 18 is a top view of the embodiment shown in FIG. 17.

FIG. 19 is a front view showing a portion of another embodiment of the present invention.

FIG. 20 is a top view of other components of the embodiment of FIG. 19 and the components of FIGS. 19 and 20 assemble to create this alternative embodiment.

FIG. 21 is an offset top view of the assembled embodiment shown in FIGS. 19 and 20.

FIG. 22 is an offset top view of an optional component for the embodiment of FIG. 21.

FIG. 23 is an offset bottom view of the component of FIG. 22.

FIG. 24 is a partial offset top view of the device of a preferred embodiment.

FIG. 25 is an offset top view of a smooth floor attachment device of the present invention.

FIG. 26 is a partial offset top view of the present invention.

### DESCRIPTION OF THE INVENTION

Possible embodiments will now be described with reference to the drawings and those skilled in the art will understand that alternative configurations and combinations of components may be substituted without subtracting from the invention. Also, in some figures certain components are omitted to more clearly illustrate the invention.

Common to the various preferred embodiments discussed below, a restraining device 10 includes a portion for receiving an end of a leash or tether, and this end of the tether adjusts to fit over a larger diameter knob, post, or handle having a lip and smaller diameter channel for receiving this end of the tether. Further, the restraining device includes a mechanism to selectively secure the device to the floor, whether the floor be carpet, or a more smooth surface, such as a wood floor, linoleum, or tile.

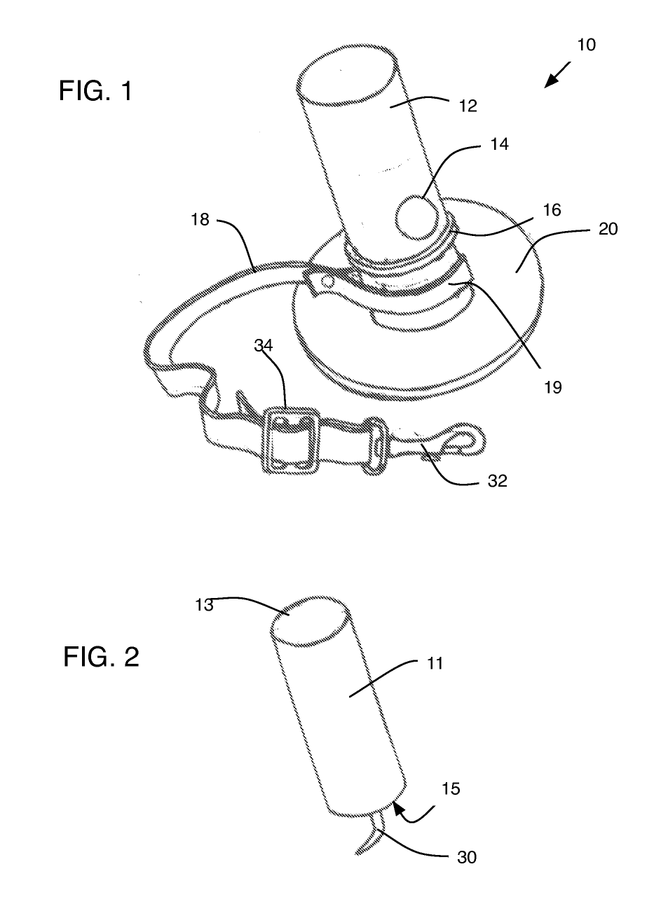

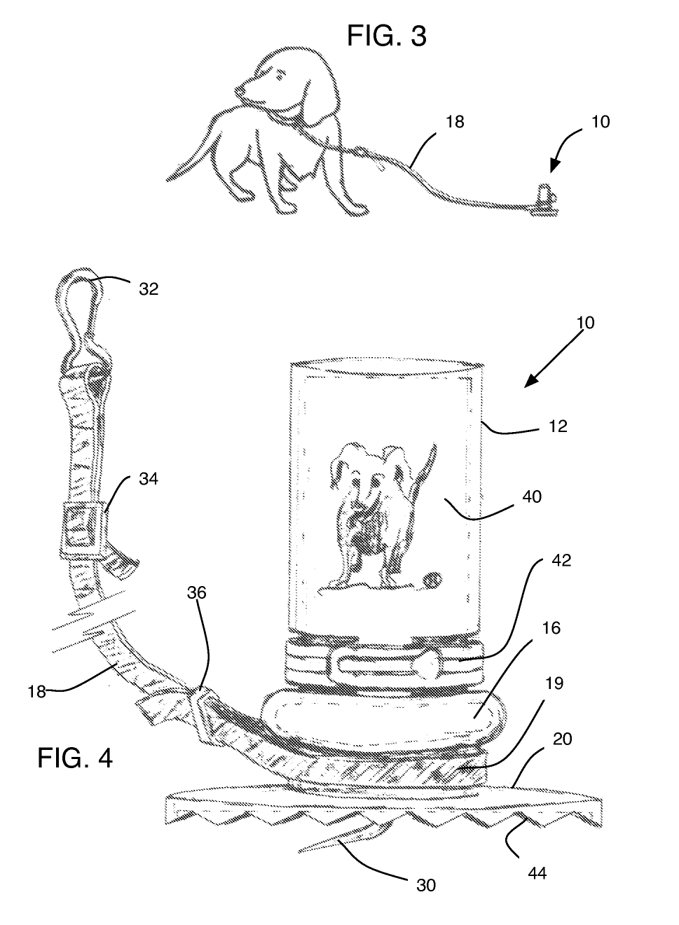

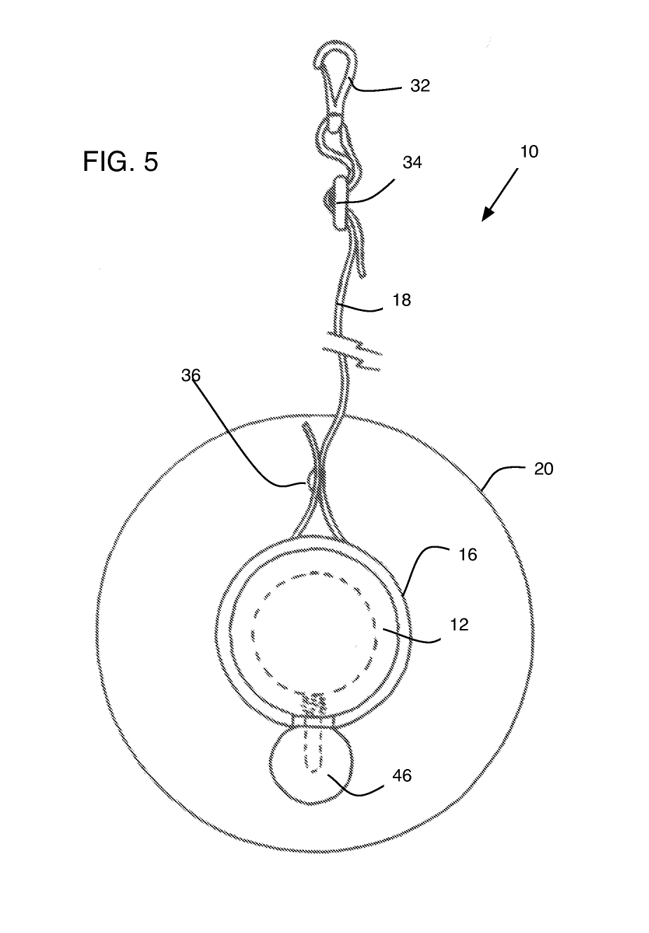

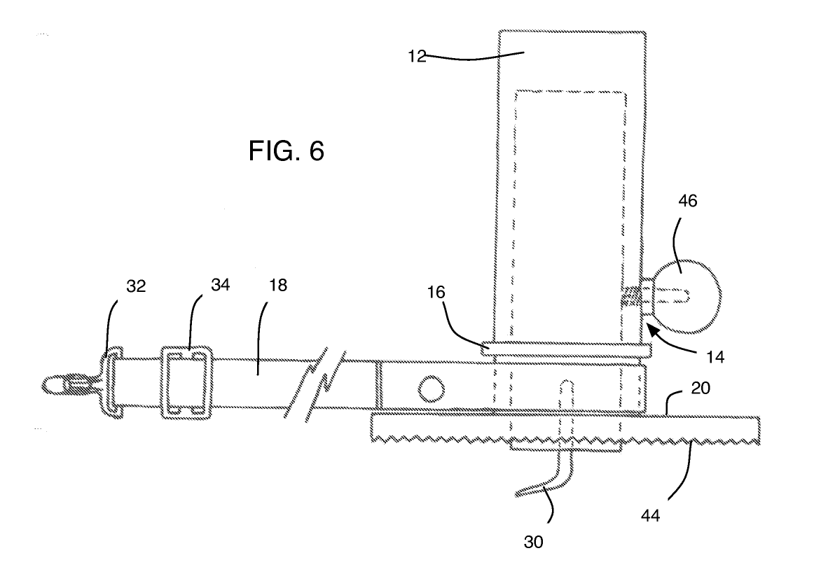

In one contemplated and preferred embodiment, for example as FIGS. 1, 2, 3, 5, and 6 illustrate, the present invention consists of a restraining device 10 for pets. The device includes a first stem 11 having a top portion 13 (which can be adapted to receive accessories such as bowl 80, for example). The first stem also includes a floor engaging means arranged at a second end 15, which consists of either a bent, central pin 30 or a suction cup (discussed in relation to a third embodiment, below). The first stem further comprising a base member 20 having bottom surface having any combination of the following, a serrated edge 44, a rubber or other rubber-like high-friction material, a hook and loop fastener material or a plurality of pins.

The device further includes a second stem 12 adapted to selectively slide over the first stem, the second stem includes a retaining lip 16 and a means for selectively coupling the second stem to the first stem 11. This coupling means comprises any combination of a setscrew adapted to pass through the second stem at a setscrew hole 14 arranged in a sidewall of the second stem: This enables a setscrew having a knob 46 and threaded end to engage a portion of the first stem 11. Other coupling means include a retaining clip 42 (as illustrated in a second preferred embodiment of FIG. 4, for example) arranged around the second stem to pinch the second stem in place over the first stem, or a rotor clip, ratchet-ball, plunger, or friction setting (all of which are not illustrated in the drawings).

And, the device further includes a strap 18 having a primary end having a loop 19 and the loop arranging around the second stem below the retaining lip 16, the strap having an opposite secondary end having a means for attaching the strap to the pet, the means comprising any combination of a swivel hook 32, clasp, buckle, retaining pin, carabiner, or threaded fastener.

The strap 18 may be elastomeric or semi-rigid, a linked chain, cloth, rope, nylon leash, or other known and well-understood materials and devices used to leash a pet, as would be well-understood in this art. The strap may include a tri-guide to adjust the length and other retaining clips. The tether 18 also can include an elastomeric portion to further reduce injury-propensity, and this would allow linear stretching of the tether when pulled on by the pet. Further, a hook and loop portion or other mechanical release feature is contemplated in the strap or tether so that at a pre-determined threshold the strap will release or break or otherwise disengage if the pet pulls past the threshold portion.

Further, the strap or tether 18 can include a mechanism for adjusting length of the tether 34, as it would be understood that in some circumstances a longer or shorter tether may be required to keep a pet out of mischief. And the tether needs to adjust to fit over the knob or handle, but then adjust to a smaller size once placed over the restraining device and to prevent the tether from slipping off the post. Accordingly, the tether includes an adjuster 36 at the post end.

One contemplated material for the first and second stems is PVC PIPE, available from HOME DEPOT home improvement stores, which are available in most every community in the United States including, for example, Beaverton, Oreg. One contemplated material for the central bent pin includes stainless steel, one exemplary suction cup is part number QEP 75000-6 available from QEP Professional Tools of Boca Raton, Fla., USA; one suitable bottom surface includes a VELCRO brand hook and loop fastener, or a ROBERTS brand 10-412-03 NAP GRIP arrangement of pins, or a QEP/BRUTUS brand rubber material, or a serrated edge carved, molded, machined, or otherwise formed in the base material. One contemplated material for the strap is an elastic strap having a length of 4′ adjustable from 1.5′ to 3.5′, and width of 1″. One possible swivel hook is 1″ medium sized plastic hooks generally available from USA Lanyards, Co. (www.USALANYARDS.COM) of Walnut, Calif., having a part number P-005-25.

The tether 18 or strap may be selectively coupled to the pet by means of a traditional pet collar or chest harness, as would be well understood by those of ordinary skill in the art. Preferably, the tether would include a fail-safe mechanical device that would uncouple the tether from the stay at a certain threshold so to prevent serious injury to the animal. One contemplated embodiment of a tether includes a modification to the tether by having a hook and loop fastener means for attaching the tether to the stay by having either the hook or, alternatively, the loop end of the fastener at one end of the tether and the mating portion of the hook and loop fastener at an intermediate position on the length of the tether. Then the end is wrapped around the stay, or through a portion of the stay, and the end is overlapped on the mating hook and loop fastener. This same concept would work with snaps or plastic prong collar closers as well.

A second preferred embodiment, as FIG. 4 shows, includes the same or similar construction as the first preferred embodiment previously described. Additionally, the second stem includes a logo placement area 40, which is well-suited for marking the device 10 with a logo or advertisement. A retaining ring clip 42 selectively pinches the second stem over the top of the first stem. A retaining feature 16 consists of a rubber ring. Common features to the first embodiment are not described here in the interest of brevity.

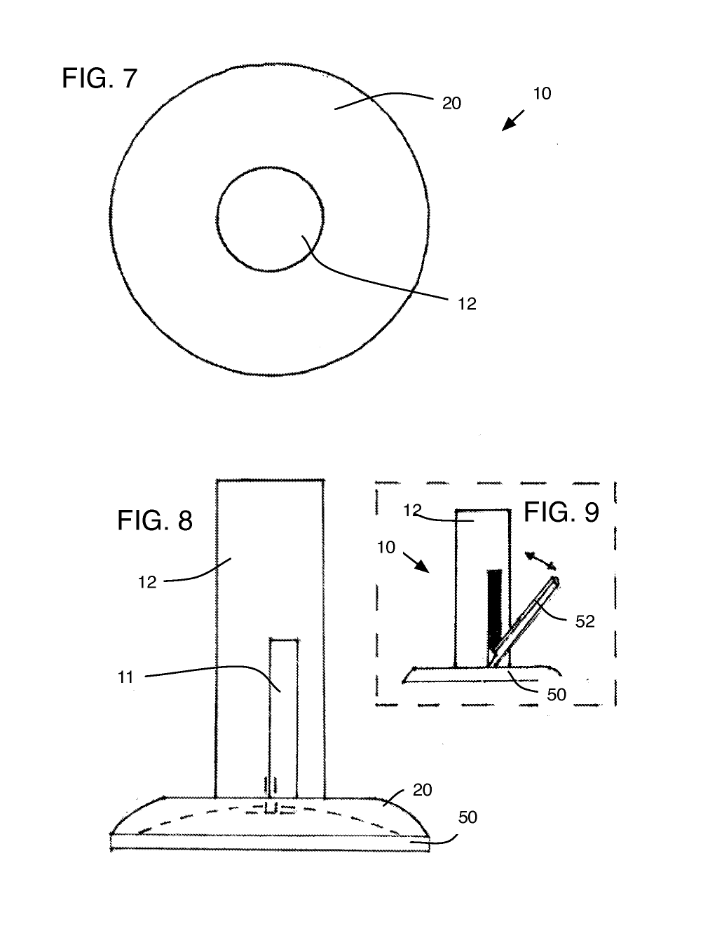

A third preferred embodiment, for example, as FIGS. 7-9 show, includes a base 20 having a suction cup 50 for releasably coupling to a smooth floor surface (such as tile, linoleum, wood, cork, vinyl and the like). Other features and elements are similar to the first two embodiments and, accordingly, are not repeated in detail here. Of note, in this embodiment the base includes a suction device 50 that includes a release lever 52 that aids in evacuating the space between the cup and the floor to make a strong vacuum bond between the device 10 and the floor and further, the release can selectively enable air to enter the cup to release the device from the floor.

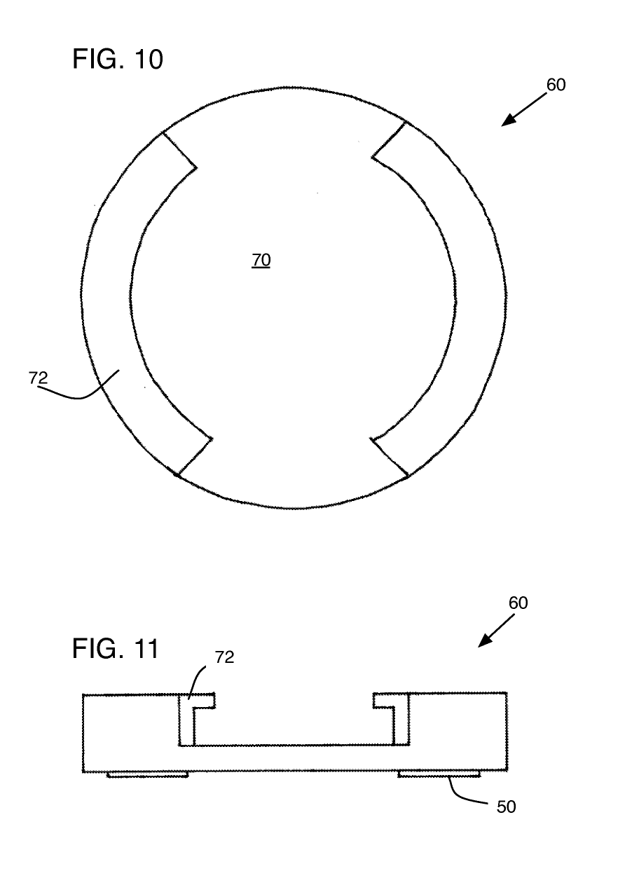

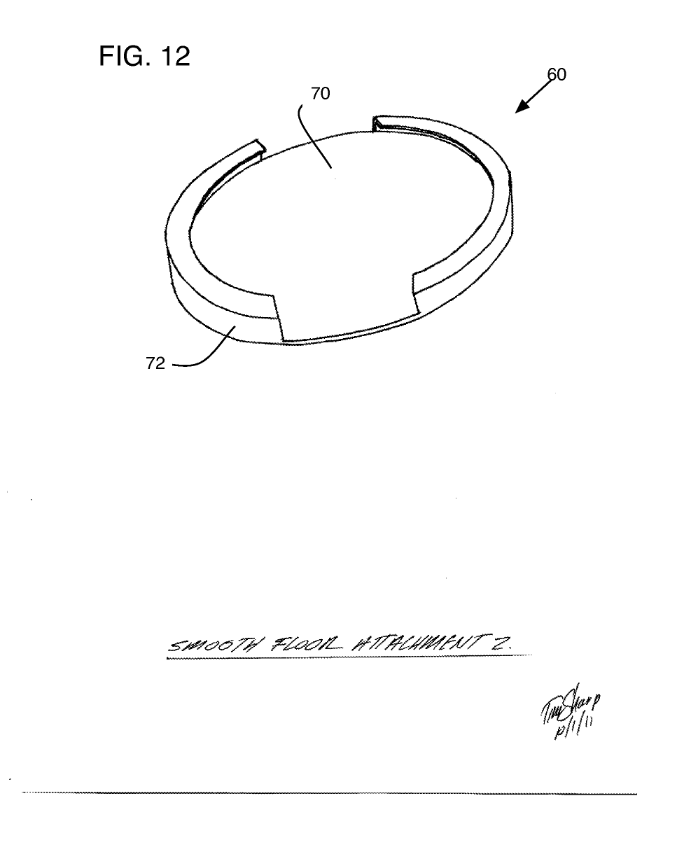

A smooth floor attachment 60, as FIGS. 10-13 show, can be adapted for use with any of the preferred embodiments. As such, it includes a base 70 and pair of retainers 72, which are adapted to engage the base member 20. The underside of the base 70 includes a mechanism to selectively affix the smooth floor attachment 60 to a smooth surface such as hardwood, linoleum, tile, and the like. This attaching mechanism, in one iteration, includes a reusable adhesive 51 such as a common 3M brand reusable adhesive tape such as, for example, 3M company's “Command” brand adhesive tape available at http://www.command.com/wps/portal/3M/en_US/NACommand/Command/Products/Catalog/%7E/Command-Large-Refill-Strips?N=5924794&rt=rud, or alternatively, TAP brand double-stick foam tape having a foam backing of about 1/16″ thick and available from http://www.tapplastics.com/product/repair_products/adhesive_tapes/double_s tick_foam_tape/405, or 3M company's 4004-brand double-sided foam tape available from http://www.uline.com/Product/Detail/S-10057/Double-Sided-Foam-Tape/3M-4004-Double-Sided-Foam-Tape-1-2-×-18-yards.

Alternatively, in another iteration a suction-type plunger 50 (as FIGS. 8 and 9 illustrate) is used to attach the restraint device 10 to smooth surfaces. Also contemplated is a more rigid coupling to the baseboard or other structural members inside a room using screws extending through the smooth-floor attachment device 60 and into the structural member (such as the baseboard, wall stud, and the like).

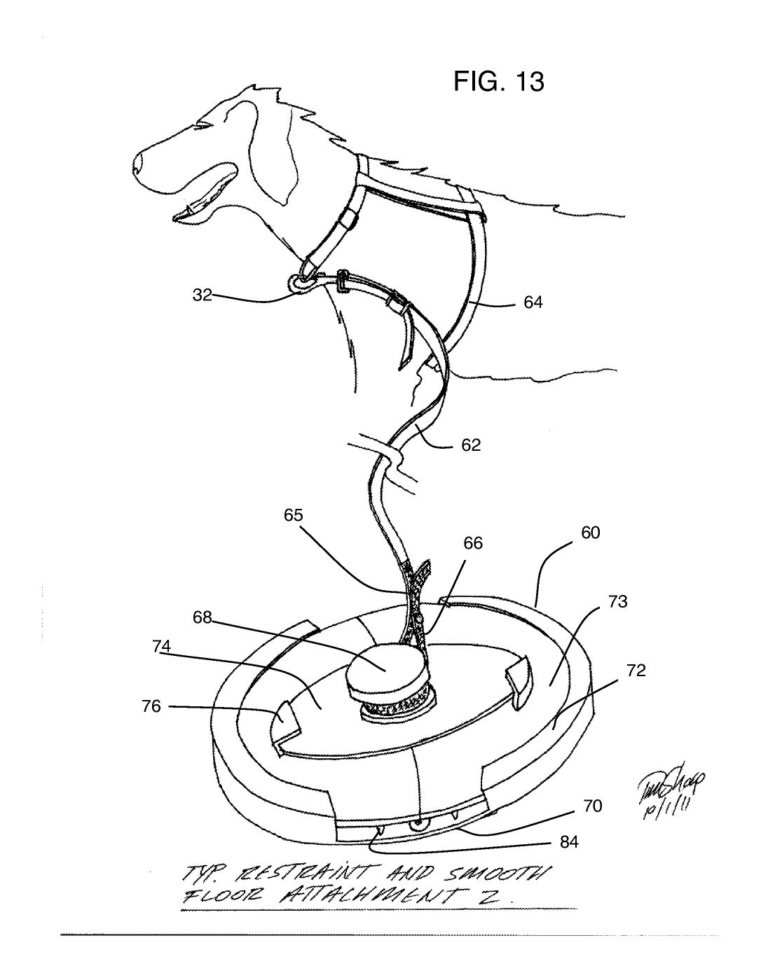

With specific reference to FIG. 13, the smooth floor attachment 60 couples to the main disc body 73 by the pair of retainers 72. The gripping elements 84 are fully enclosed by the base 70 of the smooth floor attachment 60. The second post 68 remains exposed to enable the tether 62 to normally attach to the device 10. The tether includes adjusting means 65 to enable one end to slip over the post 68 and then reduce in size to prevent that end of the tether from slipping back over the post. The tether may include a shoulder strap 64 and length adjusting means as well as a clip 32 to attach to a dog collar.

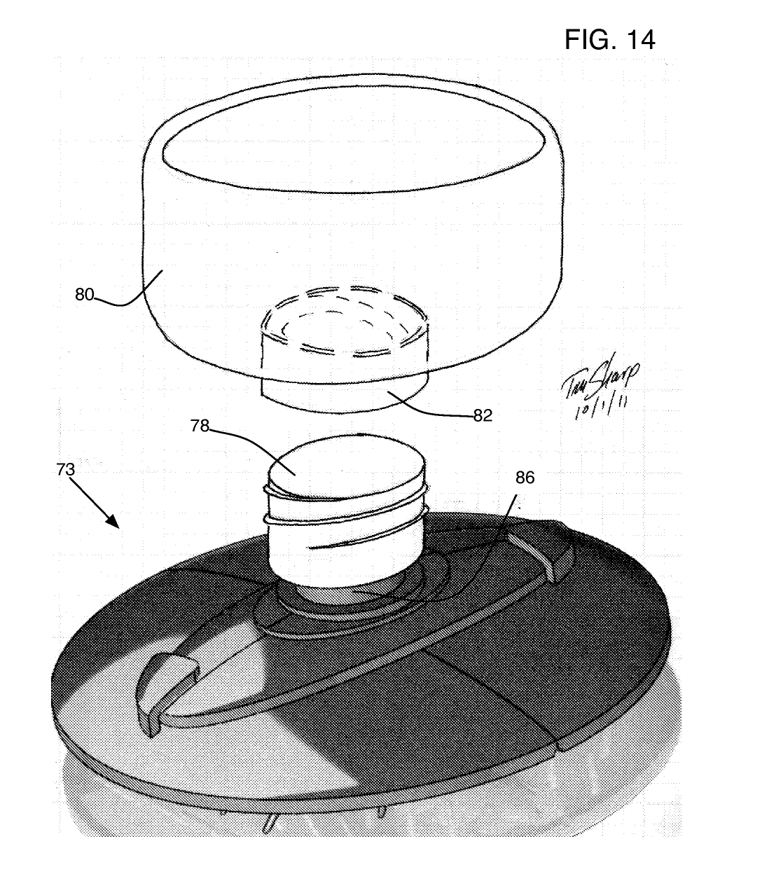

FIG. 14 illustrates an accessory, a bowl 80 for water or food, for example. This accessory adapts to couple to the second post of any of the preferred embodiments and optionally includes a screw post 78, which adapts to encapsulate a portion of the pose. The bowl 80 then selectively couples to the device 10.

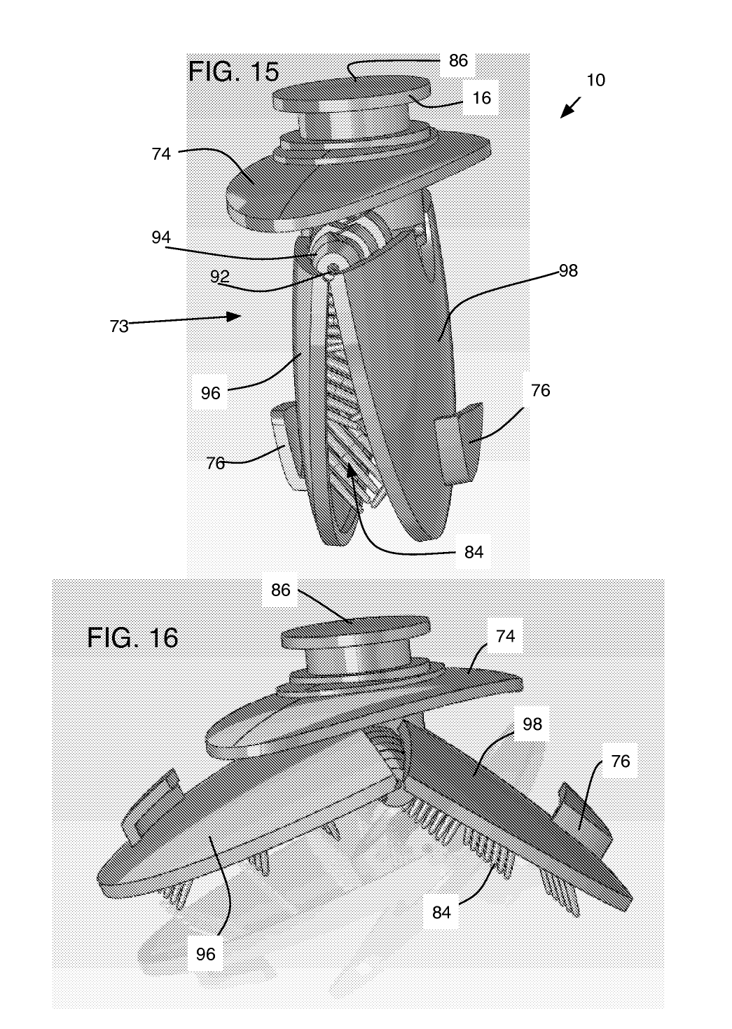

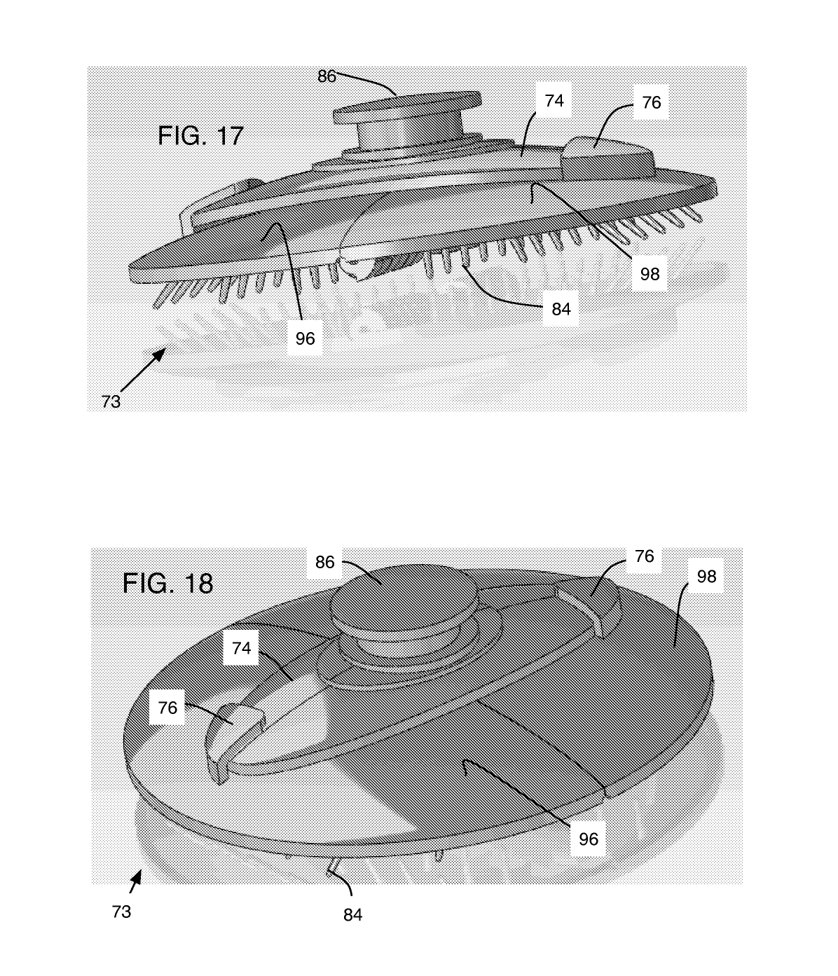

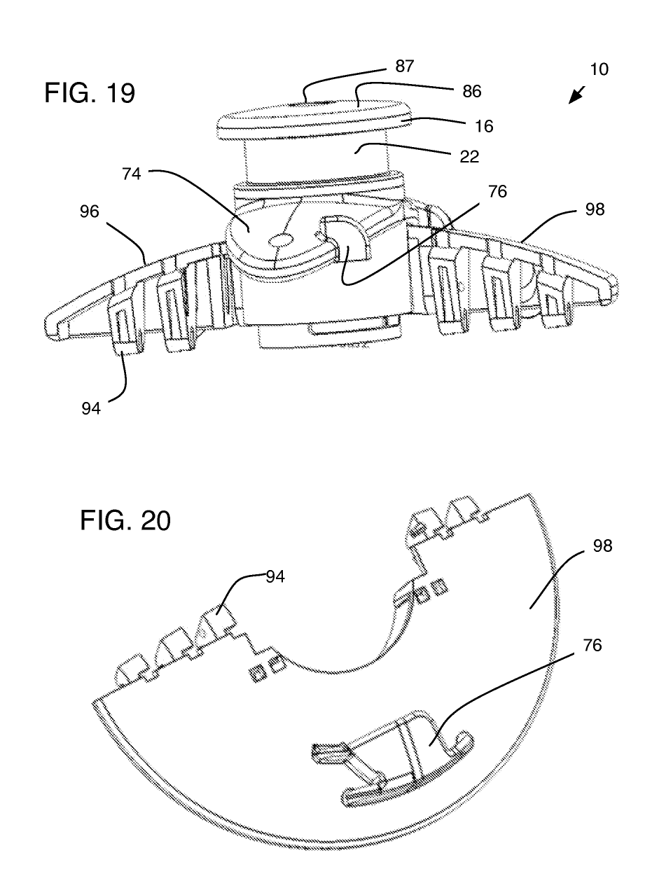

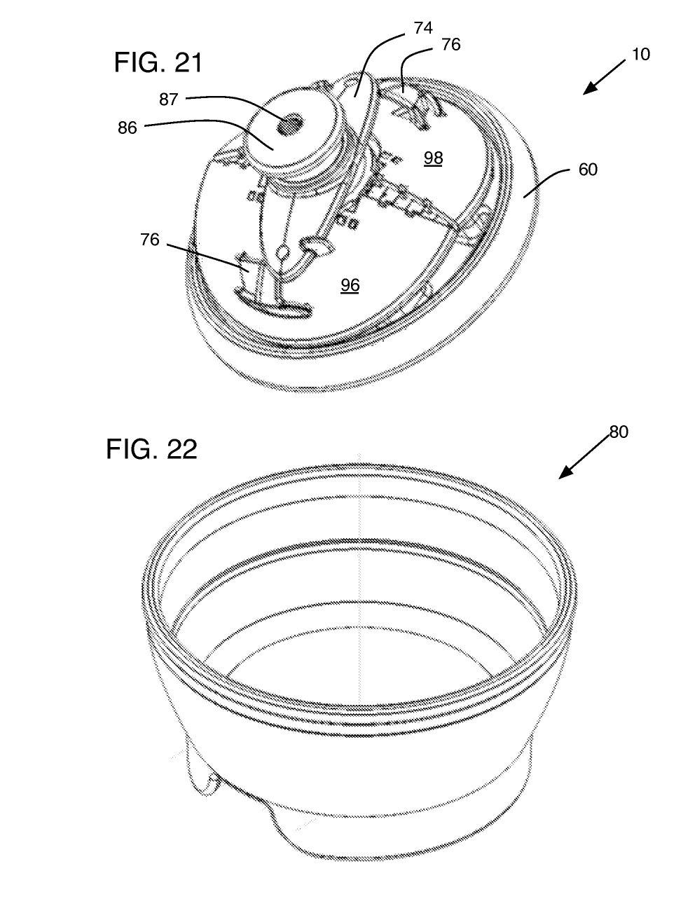

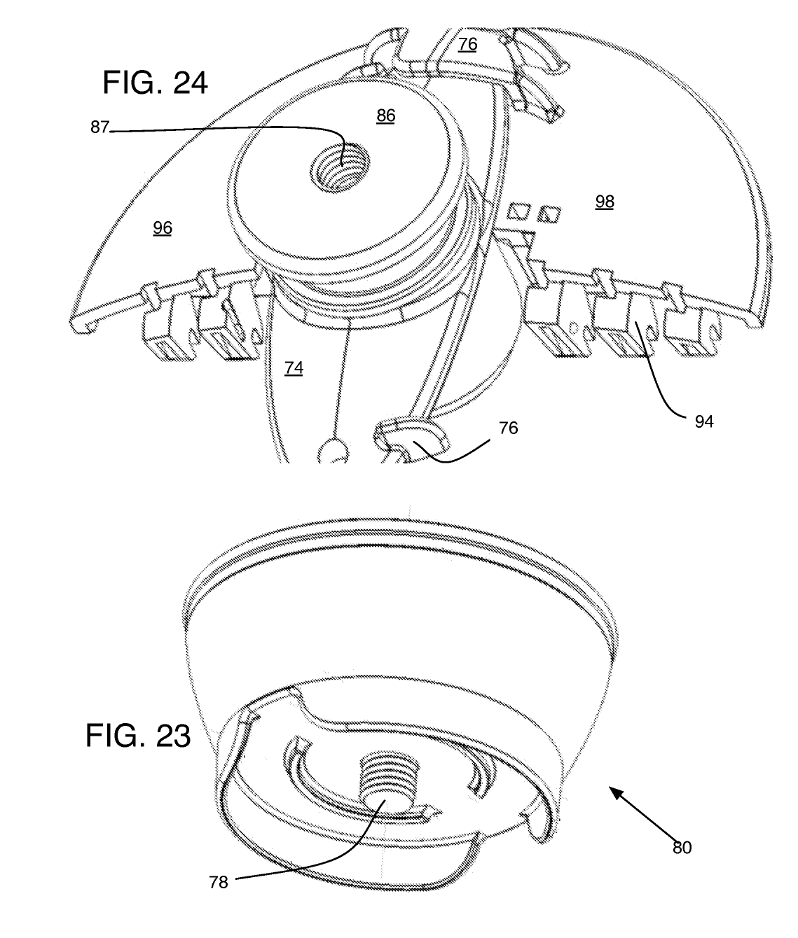

With particular reference to FIGS. 15-24, the main disc body 73 includes a locking plate 74. The locking plate carries a knob 86 including a retaining lip 16. The knob performs two primary functions: It serves as a retainer and rest for the tether or strap 18 and it is used to twist the locking plate from the closed position (of FIG. 15) to an open position (of FIG. 18, for example). The main disc body further includes a hinge 94 with hinge pin 92. The hinge supports a left and right disc portion 96 and 98, respectively. Each disc portion includes a retainer 76. In the closed position, as FIG. 15 shows for example, the disc body captures the plurality of carpet gripping elements 84 (spikes). In the open position the spikes 84 are ready to engage a carpet. FIGS. 17 and 18 better show the disk body 73 in the open position.

As mentioned, the fourth preferred embodiment, for example as FIGS. 10-13 show, includes a smooth floor attachment 60 with a low profile tray, which is well suited for an adhesive-type bottom 50. The smooth floor attachment 60 includes a base 70 with at least one and preferably two oppositely positioned retainers 72 that has an over extending upper lip to make an inverted-L shaped channel with the base. The attachment 60 receives the main disc body 73, which is held in place by the cooperating retainers 72, as FIG. 13 shows, for example.

FIG. 14 illustrates an accessory for the fourth embodiment discussed above. The main disc body 73 receives a screw post 78, which slides over the knob 86. The screw post can be made of a hard rubber-like material that deforms slightly as it is inserted over the knob, but reforms and matches the contour of the knob. A bowl 80 including an attachment portion 83 mates to the screwpost 78. The tether (not shown in FIG. 14) attaches as per normal and operates normally, but the pet now has a bowl for drinking water, and this bowl is less likely to spill because it is fixably attached to the device 73, which is attached to the carpet, for example (this bowl 80 would also work when the disc body 73 is in the smooth floor attachment 60 of FIGS. 10-13, for example).

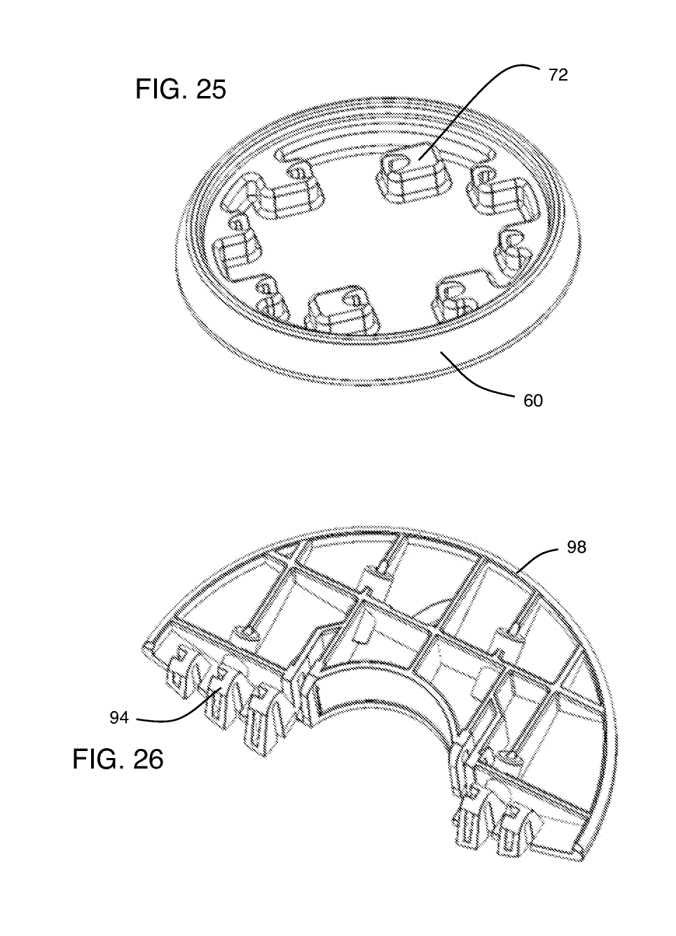

With specific reference to FIGS. 15-25, this preferred embodiment of a restraining device 10 for temporarily coupling a domestic animal to a floor includes a post 86 comprising a retaining lip 16 and tether-resting channel 22. The post 86 is generally cylindrical and disposed generally upright and arranged generally orthogonal relative to the disc body 73, locking plate 74 and left and right (or first and second) locking wings 96, and 98, respectively. A locking plate 74 couples to the post below the resting channel and is coupled to the post whereby rotation of the post causes corresponding rotation of the locking plate, and rotation of the locking plate, in turn, causes the first and second locking wings to move from the compact folded position to a flat, floor-engaging position and back. Accordingly, a first 96 and second 98 locking wing hingeably couple to the post by means of hinge 94 having a hinge pin 92 and are adapted to be operable from a compact, closed position (see, e.g. FIG. 15) to a generally disc-like open position (see, e.g. FIG. 17). Each locking wing includes a top-mounted locking feature retainer 76 to selectively engage the locking plate when the locking plate is twisted clockwise (to lock) and disengages when twisted the opposite direction. On the bottom side of the disc body 73, each respective first and second locking wing each include a plurality of carpet-engaging spikes 84. One possible set of carpet-engaging spikes 84 includes part number 17-800-15 “Sharkteeth Nap Grips” available from Taylor Tools of Bloomington, Minn., USA. As such, the bottom of the disc body is adapted to receive these hardened stainless steel blades so that they can be snapped in and then locked down using a fastener, and removed for replacement, if needed.

This device 10 of FIGS. 15-25 further includes a smooth floor attachment device 60 adapted to selectively couple to the first and second locking wings 96 and 98 when in the open position, the smooth floor attachment device 60 comprising a base 70 having oppositely disposed pair of retainers 72 on a top portion and a mechanism for selectively attaching the base to the floor on a bottom portion. The mechanism for selectively attaching the base 70 includes at least one plunger 50 disposed on the bottom portion. Or, alternatively, the mechanism for selectively attaching the base 70 include at least one adhesive strip 51 arranged on the bottom portion.

The device 10 further adapts to support a bowl 80 or other similar accessory. The bowl 80 adapts to selectively couple to the post by means of a threaded post (either internal or external).

The device 10 further adapts to receive a tether 18 (or 62) having a first end adapted to slide over the post 86 and adjust from a first diameter to a second diameter whereby the first diameter is large enough to fit over the post and the second diameter is large enough to slide on the channel but not slip over the retaining lip.

Although the invention has been particularly shown and described with reference to certain embodiments, it will be understood by those skilled in the art that various changes in form and detail may be made without departing from the spirit and scope of the invention. And, although claims are not required, I claim at least:

We claim:

1. A restraining device for temporarily coupling a domestic animal to a floor, the device comprising:
a post comprising a retaining lip and tether resting channel;
a locking plate coupled to the post below the resting channel;
a first and second locking wing hingeably coupled to the post and adapted to be operable from a compact, closed position to a generally disc-like open position, each locking wing including a top-mounted locking feature retainer to selectively engage the locking plate, and
the first and second locking wing each respectively further comprising a plurality of carpet-engaging spikes.

2. The device of claim 1 further comprising:
a smooth floor attachment device adapted to selectively couple to the first and second locking wings when in the open position, the smooth floor attachment device comprising a base having oppositely disposed pair of retainers on a top portion and a mechanism for selectively attaching the base to the floor on a bottom portion.

3. The mechanism for selectively attaching the base of claim 2 comprising: at least one plunger disposed on the bottom portion.

4. The mechanism for selectively attaching the base of claim 2 comprising: at least one adhesive strip arranged on the bottom portion.

5. The device of claim 1 further comprising:
an accessory bowl adapted to selectively couple to the post.

6. The device of claim 1 further comprising:
a tether having a first end adapted to slide over the post and adjust from a first diameter to a second diameter whereby the first diameter is large enough to fit over the post and the second diameter is large enough to slide on the channel but not slip over the retaining lip.

7. A restraining device comprising:
a post comprising a retaining lip and tether-resting channel;
a plate coupled to the post below the resting channel, the plate adapted to receive at least one carpet-engaging spike.

8. The device of claim 7 wherein:
the plate further comprises a plurality of serrated teeth on a portion of a bottom surface.

9. The device of claim 7 further comprising:
the plate comprises a locking plate coupled to the post below the resting channel; and
a first and second locking wing hingeably coupled to the post and adapted to be operable from a compact, closed position to a generally disc-like open position, each locking wing including a top-mounted locking feature retainer to selectively engage the locking plate, and
the first and second locking wing each respectively further comprising a plurality of carpet-engaging spikes.

10. The device of claim 7 further comprising:
a smooth floor attachment device adapted to selectively couple to the post and further adapted to encapsulate the at least one carpet spike, the smooth floor attachment device comprising a base having oppositely disposed pair of retainers on a top portion, the retainers adapted to selectively receive the plate, and the base further comprising a suction cup mechanism for selectively attaching the base to the floor on a bottom portion.

11. The device of claim 9 further comprising:
a smooth floor attachment device adapted to selectively couple to the first and second locking wings when in the open position, the smooth floor attachment device comprising a base having oppositely disposed pair of retainers on a top portion and a mechanism for selectively attaching the base to the floor on a bottom portion.

12. The mechanism for selectively attaching the base of claim 11 comprising: at least one adhesive strip arranged on the bottom portion.

13. The device of claim 7 further comprising:
an accessory bowl adapted to selectively couple to the post.

14. A method of tethering a domestic animal to an interior floor surface, the method comprising:
providing a restraining comprising a post comprising a retaining lip and tether resting channel; a locking plate coupled to the post below the resting channel; a first and second locking wing hingeably coupled to the post and adapted to be operable from a compact, closed position to a generally disc-like open position, each locking wing including a top-mounted locking feature retainer to selectively engage the locking plate, and the first and second locking wing each respectively further comprising a plurality of carpet-engaging spikes;
providing a tether and coupling one end of the tether to the domestic animal;
adjusting a second end of the tether to fit over the post and engaging the second end of the tether to fit inside the tether resting channel; and
adjusting the second end of the tether to remain in the tether resting channel and not slip back over the post.

15. The method of claim 14 further comprising:
providing a smooth floor attachment device adapted to selectively couple to the first and second locking wings when in the open position, the smooth floor attachment device comprising a base having oppositely disposed pair of retainers on a top portion and a mechanism for selectively attaching the base to the floor on a bottom portion;
engaging the smooth floor attachment device to the locking wings; and
placing the smooth floor attachment device on the floor.
